(19) United States
(12) Patent Application Publication
(10) Pub. No.: US 2024/0406055 A1
(43) Pub. Date: Dec. 5, 2024

(54) Network Issue Identifications

(71) Applicant: Hewlett-Packard Development Company, L.P., Spring, TX (US)

(72) Inventors: Irwan Halim, Spring, TX (US); Christoph Graham, Spring, TX (US)

(73) Assignee: Hewlett-Packard Development Company, L.P., Spring, TX (US)

(21) Appl. No.: 18/689,044

(22) PCT Filed: Sep. 15, 2021
(86) PCT No.: PCT/US2021/050514

§ 371 Date: Mar. 4, 2024

(51) Int. Cl. H04L 41/06; H04L 43/0817; H04L 45/28; H04W 28/04; H04W 28/08

(52) U.S. Cl. CPC H04L 41/06; H04L 43/0817; H04L 45/28; H04W 28/04; H04W 28/08

(57) ABSTRACT

In some examples, a method includes receiving, at a management server, network performance information from a managed node. In some examples, the network performance information includes data corresponding to an unmanaged link between the managed node and an unmanaged target device. In some examples, the method includes identifying a network issue with the unmanaged link based on the data. In some examples, the method includes generating a notification indicating the network issue.

### BACKGROUND

Computing devices are a kind of electronic device that include electronic circuitry for performing processing. As processing capabilities have expanded, computing devices have been utilized to perform more functions. For example, a variety of computing devices are used for work, communication, and entertainment. Computing devices may be linked to a network to facilitate communication between computing devices.

### BRIEF DESCRIPTION OF THE DRAWINGS

FIG. 1 is a flow diagram illustrating an example of a method for network issue identifications;

FIG. 2 is a thread diagram illustrating an example of network issue identification;

FIG. 3 is a block diagram of an example of an apparatus that may be used for network issue identification; and

FIG. 4 is a block diagram illustrating an example of a computer-readable medium for network issue identification.

### DETAILED DESCRIPTION

An electronic device is a device that includes electronic circuitry (e.g., integrated circuitry, etc.). A computing device is an electronic device that includes a processor and/or logic circuitry. Examples of computing devices may include desktop computers, laptop computers, servers, tablet devices, smartphones, tablet device, televisions, game consoles, smart speakers, voice assistants, etc. A computing device may utilize processor(s) and/or logic circuitry to perform an operation or operations. In some examples, computing devices may execute instructions stored in memory to perform the operation(s). Instructions may be code and/or programming that specifies functionality or operation of the circuitry. In some examples, instructions may be stored in non-volatile memory (e.g., Read-Only Memory (ROM), Erasable Programmable Read-Only Memory (EPROM), Electrically Erasable Programmable Read-Only Memory (EEPROM), flash memory, etc.).

In some examples, an electronic device (e.g., computing device) may be coupled to another electronic device or devices using a link. A link is a communication channel(s) between electronic devices. A link may include (and/or may be supported by) a physical connection or connections. Examples of physical connections may include wired connections (e.g., wires, cables, fiber optic cables, etc.) and/or wireless connections (e.g., radio frequency (RF) channels). A link between electronic devices may be a direct link (e.g., without an intervening device) or an indirect link (e.g., with an intervening device or devices). For instance, a link may be established between electronic devices over a network using a modem(s), router(s), switch(es), hub(s), and/or repeater(s), etc.

In some examples, an electronic device may include a communication interface for communicating with another electronic device(s) (e.g., switch(es), router(s), server(s), and/or computer(s), etc.). Examples of wired communication interfaces may include an Ethernet interface, Universal Serial Bus (USB) interface, fiber interface, Lightning® interface, etc. In some examples, a computing device may include a wireless communication interface to send and/or receive wireless (e.g., RF) signals. Examples of wireless communication interfaces may include an Institute of Electrical and Electronics Engineers (IEEE®) 802.11 (WI-FI®) interface, Bluetooth interface, cellular (e.g., 3G, Long-Term Evolution (LTE®), 4G, 5G, etc.) interface, Zigbee® interface, etc.

In some examples, a link may be supported by a network or networks. A network is a group of connected electronic devices. A network may include a wired connection(s), a wireless connection(s), or a combination thereof. Examples of networks may include local area networks (LANs), wide area networks (WANs), personal area networks (PANs), mesh networks, wireless LANS (WLANs), cellular networks, the Internet, WI-FI networks, Bluetooth networks, Zigbee networks, etc.

A network issue is an event or condition that affects network performance (e.g., negatively affects network performance). Network issues may affect networks in public, private, and/or commercial settings. For information technology (IT) administrators, for instance, network issues may be difficult to identify and/or resolve. For example, a network issue may be difficult to troubleshoot, which may cause an IT administrator to attempt to remotely access an electronic device that is experiencing the network issue. Some network issues may be challenging to identify, as some network issues occur intermittently or occur under certain conditions. Some conditions that can cause network issues may include network congestion (e.g., high network load), malfunctioning network infrastructure (e.g., routing and/or switching failure, devices with sub-optimal settings, etc.), power failure, etc.

With the use of virtual and/or remote computing environments becoming more prevalent, IT administrators face challenges when setting up a remote connection host on managed devices. Managed devices may connect to a remote server based on physical location, which may result in network congestion in a certain location.

Some examples of the techniques described herein may compile network performance information. In some examples, network performance information may include data such as network hops, latency, dropped packets, etc. In some examples, data collection is delegated to devices that are selected to help ensure efficiency and/or to avoid negatively effecting user experience. In some examples, the data may be aggregated according to a variable or variables to identify network issues such as network congestion, server malfunction, proxy server issue, etc. Some examples of the techniques described herein may be utilized to reduce the impact of a network issue or issues.

Throughout the drawings, similar reference numbers may designate similar or identical elements. When an element is referred to without a reference number, this may refer to the element generally, without limitation to any particular drawing or figure. In some examples, the drawings are not to scale and/or the size of some parts may be exaggerated to more clearly illustrate the example shown. Moreover, the drawings provide examples in accordance with the description. However, the description is not limited to the examples provided in the drawings.

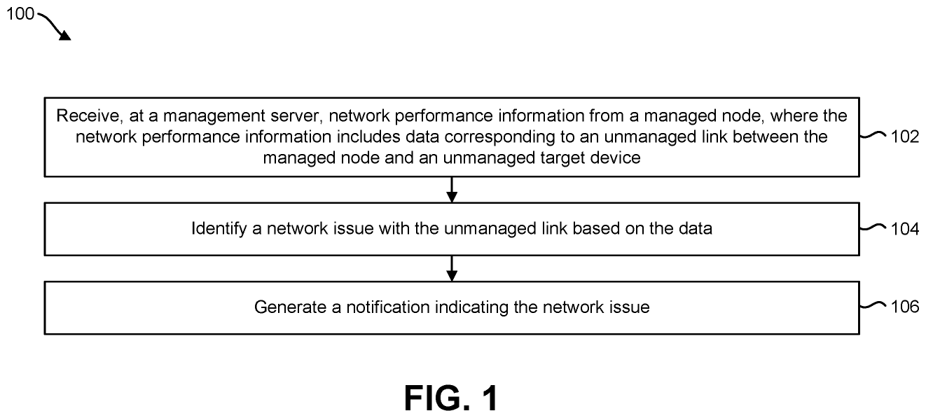

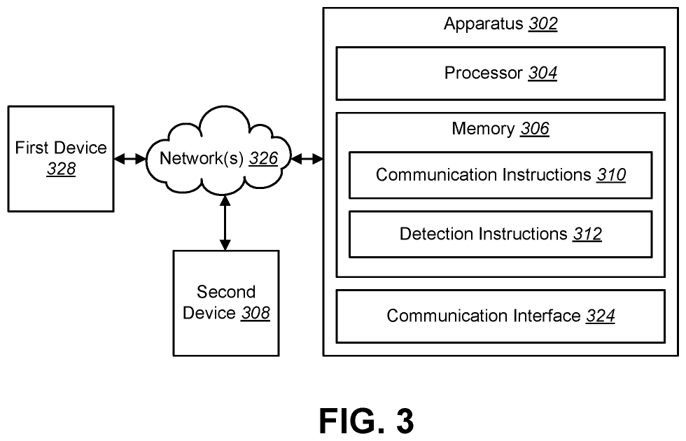

FIG. 1 is a flow diagram illustrating an example of a method 100 for network issue identifications. The method 100 and/or a method 100 element or elements may be performed by an apparatus (e.g., computing device, server, etc.). For example, the method 100 may be performed by the apparatus 302 described in relation to FIG. 3. In some examples, the apparatus is a management server.

A management server is a server that manages an electronic device or devices (e.g., managed node(s)). For instance, a management server may manage a managed node over a network or networks. Managing a managed node may include monitoring the status of a managed node, directing the managed node to perform an operation(s), and/or receiving data from a managed node. A managed node is an electronic device (e.g., computing device) that performs an operation(s) directed by a management server and/or that collects data for a management server. In some examples, a managed node may be a remote device. A remote device is a device that is separate from the apparatus (e.g., management server). In some examples, a remote device may be linked to the apparatus via a network or networks. In some examples, a management server may have administrative access to a managed node. Administrative access is a capability to (e.g., permission to) control privileged functions (e.g., install/uninstall program(s), access all storage, change account information, and/or change security settings, etc.). In some examples, the management server provides a management environment. A management environment is an application or program that provides administrative functions to manage an electronic device or devices (e.g., managed nodes). In some examples, managed nodes are electronic devices that are within the management environment and/or under administrative control of the management server. Examples of management environments include HP Device Manager (HPDM), Microsoft Endpoint Configuration Manager, etc.

In some examples, a managed node may include an agent. An agent is an application or program that performs an operation on behalf of another device or program. For instance, a managed node (e.g., a computing device) may have an agent installed to assist management of the node. The agent may perform an operation on the managed node as directed by the management server. For instance, the management server may send a task or tasks to a managed node over the network(s). The agent on the managed node may receive the task(s) and/or perform the task(s) indicated. In some examples, a management server may have increased access and/or permission(s) for a managed node than another device (e.g., an unmanaged device, an unmanaged target device, etc.). In some examples, a managed node may collect and/or report data (e.g., hardware inventory, program inventory, settings, and/or runtime characteristics (such as logs)) that are addressable and/or obtainable by a management server. In some examples, a managed node may be controlled by a management server through the remote deployment of a program(s) and/or a script(s). In some examples, a managed node may be monitored by a management server through the reporting of device health information. In some examples, a managed node may be controlled by a management server to change characteristics of the managed node, such as changing an operating system or operating system components, installation or uninstallation of a program(s), and/or modification of settings to change the working characteristics of the managed node. In some examples, a management server and a managed node may be owned by a same entity (e.g., company). For instance, an entity may own a management server and may provide (e.g., lend, supply, lease, etc.) managed nodes to employees. In some examples, a management server and managed nodes may be owned by and/or provided by a service provider.

The method 100 includes receiving 102, at a management server, network performance information from a managed node. The network performance information includes data corresponding to an unmanaged link between the managed node and an unmanaged target device. Network performance information is information indicating an aspect or aspects of network performance. Examples of network performance information may include a quantity of network hops (e.g., quantity of network devices between a source device and a destination device to transmit data and/or receive data), latency (e.g., round trip time (RTT), response delay, ping time, etc.), quantity of dropped packet(s) (e.g., quantity of packets transmitted but not received or incorrectly received, etc.), wireless signal quality metric (e.g., Wi-Fi signal strength, cellular signal strength, mesh network signal strength, Bluetooth signal strength, etc.), etc.

An unmanaged link is a link that is uncontrolled by the management server. For instance, an unmanaged link may be a link where the management server does not have access to a network device or devices (e.g., router(s), switch(s), hub(s), repeater(s), etc.) supporting the link and/or does not have control over the network device or devices supporting the link. For example, the management server may not have permission and/or access to change routing operation, modem operation, server operation, etc., for a network device or devices providing the unmanaged link. In some examples, the unmanaged link may be a link that is different from (e.g., separate from, takes a different route from, utilizes a different network device(s) from) a link between a managed node and the management server. In some examples, the unmanaged link may be carried on a network that is different (or networks that are different) from a network(s) that carries a link between the managed node and the management server. In some examples, an unmanaged link may be carried by network devices (e.g., router(s), switch(es), hub(s), server(s)), where some or all of the network devices are uncontrolled by the management server (e.g., network devices to which the management server does not have administrative access).

An unmanaged link may be utilized between a managed node and an unmanaged target device. An unmanaged target device is an electronic device (e.g., computing device, server, etc.) that is uncontrolled by the management server. For instance, the unmanaged target device may be an electronic device (e.g., third-party server) that the management server does not control and/or for which the management does not have administrative access (e.g., permission to control). In some examples, the unmanaged target device may be owned by a different entity than the management server. The term “third party” and variations thereof may be utilized to denote an item or element provided by a party different from and/or separate from an entity that owns and/or controls a management server.

In some examples, the managed node may collect the data corresponding to the unmanaged link between the managed node and the unmanaged target device. In some examples, the management server may send a task to the managed node to collect the data. A task is an instruction or assignment to perform an operation or operations. For instance, the management server may send a task to the managed node via the link, where the task instructs the managed node to collect data (e.g., network hops, latency, dropped packets, etc.). In some examples, the task may indicate the unmanaged target device. For instance, the managed server may specify the unmanaged target device using an address (e.g., Internet Protocol (IP) address, Uniform Resource Locator (URL), etc.) and/or a device identifier.

In some examples, the task indicates a trace route procedure. A trace route procedure is the execution of an application or program that traces the path followed by a packet through a network. For instance, the trace route procedure may provide an indication of the hops followed by a packet and/or the latency of the packet for the unmanaged link between the managed node and the unmanaged target device.

In some examples, the task may indicate a socket procedure. A socket procedure is the execution of an application or program (e.g., application programming interface (API)) that sets up communication between electronic devices over a network. An example of a socket procedure is a web socket procedure. For instance, a web socket procedure may be utilized to set up a communication session between the managed node and the unmanaged target device. In some examples, a socket procedure may establish user datagram protocol (UDP) communication and/or a transport control protocol (TCP) session. TCP and UDP may be two datagram transmission modes supported by TCP/IP. The managed node may utilize the communication to determine data (e.g., hops, packet latency, etc.) for the unmanaged link between the managed node and the unmanaged target device.

In some examples, the task may indicate a third-party API procedure. A third-party API procedure is the execution of an API provided by another party (e.g., entity, company, etc.) that allows interaction between electronic devices over a network. For instance, a web service provider (e.g., Zoom®, Microsoft®, YouTube®, Amazon®, etc.) may provide an API to enable interaction between the managed node and an unmanaged target device (e.g., Zoom® server, remote desktop protocol (RDP) server, YouTube® server, Amazon® server, etc.). The managed node may utilize the API to determine data (e.g., hops, packet latency, etc.) for the unmanaged link between the managed node and the unmanaged target device. In some examples, the management server may indicate a selection and/or combination of procedures (e.g., trace route procedure, socket procedure, ping procedure, and/or third-party API procedure) in the task. For instance, some unmanaged target device(s) may not allow certain procedures (e.g., socket) to be utilized. The management server may select the task procedure(s) based on the procedure(s) allowed by the unmanaged target device(s).

In some examples, the task may include a data collection threshold or thresholds. For instance, the management server may send a task to the managed node that includes a threshold or thresholds (e.g., list of adjustable thresholds). A data collection threshold is a threshold that indicates whether to send data to the management server. Examples of data thresholds may include a latency threshold (e.g., network latency exceeded 1000 milliseconds (ms)), processor utilization threshold (e.g., processor utilization is less than 5% for an hour, etc.), memory utilization threshold (e.g., less than 20% of memory has been utilized for a half-hour, etc.), etc. The managed node may compare a metric or metrics (e.g., network latency, processor utilization, memory utilization, etc.) to a data collection threshold. If the data collection threshold is satisfied, the managed node may automatically perform data collection. The managed node may send the data to the management server when the data collection task is completed. In some examples, the managed node may raise an event to send the data to the management server when a data collection threshold is satisfied.

In some examples, the management server may select a managed node or nodes based on telemetry data. Telemetry data is data indicating a status and/or operating aspect of a managed node. Examples of telemetry data may include processor usage, available processor bandwidth, memory usage, running application(s), whether the managed node is currently being used (e.g., whether a user is logged in, whether the managed node is in a sleep mode, standby mode, awake mode, etc.), boot time, etc. For example, the management server may request and/or receive telemetry data from a plurality of managed nodes. The management server may select a managed node or nodes to perform data collection based on the telemetry data. For instance, the management server may receive telemetry data such as processor utilization, managed node location, sign in timing information, etc., that has been collected by the managed node(s). The management server may utilize the telemetry data to determine which managed node(s) to select to collect the data. For instance, the management server may select a managed node that has a threshold amount of resources available to collect data. For example, if a managed node has 10% average processor utilization or less for an hour, is in a locked screen, and/or has 80% memory resources available, the management server may select the managed node for data collection and/or may send a task to the managed node to collect the data.

In some examples, the telemetry data may include a location indicator. The location indicator may indicate a geographic location (e.g., geographic coordinates, geographic area, country, region, city, county, state, zip code, etc.) and/or a network location (e.g., subnet, network address, etc.). The managed node may select the managed node(s) based on the location indictor in some approaches. For instance, the management server may select a managed node to represent a subnet, a geographic location, a pool, or another grouping or classification.

In some examples, the managed node selection may be performed to ensure that the data collection does not overwhelm the network and/or the performance of the selected managed node. For example, in the task, the management server may specify a set (e.g., list) of unmanaged target devices (e.g., remote servers) or IP addresses from which to collect data and/or may specify a kind(s) of data to collect. For instance, the management server may request a quantity of hops from the managed node to the unmanaged target device, latency on each hop, total round-trip latency, network trace information (indicating how the traffic is routed, for example), etc. In some examples, the management server may receive data that can be correlated to network and service performance such as processor utilization, total time to complete an update, streaming video refresh rate, etc.

In some examples, the telemetry data collection and network performance information (e.g., data) collection may be performed concurrently (e.g., in overlapping time frames) or separately (e.g., telemetry data collection performed first and network performance information (e.g., data) collection performed after telemetry data collection). In some examples, a managed node may periodically perform telemetry data collection and/or network performance information (e.g., data). For instance, the telemetry data collection may trigger network performance information (e.g., data) collection based on a data collection threshold in some approaches. In some examples, network performance information (e.g., data) collection may trigger sending the data to the management server.

The method 100 may include identifying 104 a network issue with the unmanaged link based on the data. Examples of a network issue may include latency that is greater than a latency threshold, a quantity of hops that is greater than a hops threshold, quantity (e.g., number or percentage, etc.) of dropped packets that is greater than a dropped packet threshold, etc. For instance, the managed server may compare the received data to a threshold or thresholds. For example, the management server may identify a network issue when the threshold is satisfied (or thresholds are satisfied).

In some examples, the management server may receive data from multiple managed nodes and/or may identify a network issue based on the data from the multiple managed nodes. For instance, the management server may receive, from a second managed node, second data corresponding to a second unmanaged link between the second managed node and the unmanaged target device. In some examples, identifying 104 the network issue with the unmanaged link may be based on the data and the second data. In an example, the unmanaged link may include a wireless link and the data may include a wireless signal quality metric. In this example, the second unmanaged link is a wired link. Identifying 104 the network issue may include comparing the data (from the wireless link, for instance) and the second data (from the wired link, for instance). For example, if a quantity of dropped packets from the wireless link is higher than a quantity of dropped packets from the wired link and if the wireless signal quality metric is below a threshold (e.g., <25%), the managed server may identify the network issue as a poor wireless connection.

In some examples, the management server may aggregate the data received from each managed node to produce the network performance information (e.g., a dataset). In some examples, the management server may use the network performance information to map a networking path or paths and to identify potential network issues. For instance, the management server may identify a link or network path that exceeded a latency threshold, a link or network path that has exceeded a hops threshold, etc.

In some examples, the management server may aggregate the data received from the managed nodes with a specified parameter or trigger from the managed nodes to produce the network performance information (e.g., dataset) to measure health of a service(s) inside and/or outside of the managed environment. In some examples, the network performance information may indicate a network issue(s), such as trends over time (e.g., bandwidth spikes), quality of service (QOS) of application connections, warning and visibility into service disruption, and/or inefficient network routing based on managed node location.

The method 100 may include generating 106 a notification indicating the network issue. A notification is information, an indicator, and/or a message. For example, the management server may generate information and/or a message indicating the network issue(s). In some examples, the management server sends the notification to a managed node or nodes. For instance, the management server may send an alert, email, text, etc., indicating the network issue to the managed node(s). In some examples, the managed node(s) may present the notification. For instance, the managed node(s) may output a graphic, sound, and/or speech, etc., that indicates the notification. For instance, the notification may be a tailored message to a managed node or nodes experiencing connectivity issues. The notification may inform a user about the identified network issue (e.g., whether the network issue is due to a downed server, a downed proxy server, etc.).

In some examples, the notification may be a map that indicates a location (e.g., network location, network subnet, geographic location, geographic area, etc.) of the network issue. For instance, the notification may be an interactive map or alert that indicates where the networking issue is. In some examples, the map may be presented by the management server. In some examples, the map may be sent to a managed node and/or to another electronic device (e.g., administrative console).

In some examples, the notification may be a visualization. For instance, generating 106 the notification may include generating a performance analysis map, chart, or other data visualization. In some examples, the visualization may be segmented, grouped, or adjustable. For instance, a parameter (e.g., quantity of hops, latency, location, quantity of dropped packets, address, unmanaged target device, etc.) may be selected (based on received input from a user, for example), which may allow the visualization to be reorganized to be shown in terms of the selected parameter. For example, an administrator may choose to view the data from managed nodes (e.g., all managed nodes) that are linked to a certain address. In another example, an administrator may choose to view a visualization of managed nodes (e.g., all managed nodes) that are using Citrix or a Microsoft Windows Virtual Desktop (WVD) client. In another example, an administrator may choose to view a visualization of managed nodes (e.g., all managed nodes) in a geographic area (e.g., within a range from a geographic location).

In some examples, the management server may dynamically adjust a link or links (e.g., unmanaged link(s)) associated with a managed node. For example, the method 100 may include sending an instruction to a managed node to change a link route in response to identifying 104 the network issue. For instance, the management server may instruct a managed node to link to a different address and/or to direct messages to a different path. In some examples, the management server may set (e.g., send an instruction to a managed node to set or adjust) a target host, a connection to call the target host (e.g., remote desktop protocol (RDP), Citrix®, VMware®, etc.), or a combination thereof.

In some examples, the management server may generate a link profile for a managed node or nodes. For instance, the link profile may indicate different links for different conditions (e.g., different times and/or different loadings, etc.). For instance, a first managed node may be set to link to a first server (e.g., unmanaged target device) from 9 am to 11 am, and to a second server from 11 am to 5 pm. In some examples, the profile may indicate a backup server or failover server in a case that a default server is down.

Listing (1) illustrates an example of a task that may be utilized in accordance with some of the techniques described herein. Different (e.g., more or fewer) parameters may be utilized in some examples than those shown.

```
{
  “TaskID”: “{unique-ID}”,
  “Type”: “TraceRoute”,
  “Target”: “Target-Host”,
  “Thresholds”: [{
    “Interval”: “10 minutes”,
    “PacketLostMax”: “”,
    “LatencyMax”: “”,
    “RoundtripMax”: “”,
    “WlanSignalMin”:“”
  }],
  “Results”: [{
    “ExecutionTime”: “08/21/2021 15:00:05”,
    “Hops”: “10”,
    “Latency”: “200 ms”,
    “PacketLost”: “0”,
    “RoundtripTime”: “10 ms”,
    “NetworkType”: “wired”,
    “NetworkSpeed”: “1000 Mbps”,
    “WlanAP”: “”,
    “WlanSignal”: “”,
    “LastBootTime”: “08/17/2021 09:00:20”
  }]
}
```

### Listing (1)

In the example of Listing (1), TaskID is task identifier (e.g., named unique-ID), Type is a procedure identifier (e.g., indicating a trace route procedure, socket procedure, third-party API procedure, etc.), Target is a target device (e.g., unmanaged target device) address, Thresholds indicates a threshold or thresholds, Interval is a periodic trigger threshold (indicating how often the managed node is to collect data, for instance). In this example, PacketLostMax is a dropped packet threshold, LatencyMax is a latency threshold, RoundtripMax is a round trip time threshold, WlanSignalMin is a wireless signal quality threshold, Results includes data collection parameters, ExecutionTime indicates a time of data collection, Hops indicates a quantity of hops (between the managed node and a target device, for instance), Latency indicates a latency (for the link, for instance), PacketLost is a quantity of lost packets (for the link, for instance), RoundtripTime indicates a round trip time (for the link, for instance), NetworkType indicates whether a network is wired or wireless, NetworkSpeed indicates a transfer speed on the link (e.g., 1000 megabits per second (Mbps)), WlanAP indicates an access point identifier for a wireless network, WlanSignal is a wireless signal quality metric, and LastBootTime indicates a most recent boot time of the managed node.

Table (1) is an example of data collected by a managed node.

TABLE 1

| ExecutionTime | 15:00 | 15:10 | 15:20 | 15:30 | 15:40 | 15:50 |
|---|---|---|---|---|---|---|
| Latency | 200 | 300 | 300 | 1200 | 800 | 200 |
| PacketLost | 0 | 0 | 0 | 2 | 1 | 0 |
| RoundtripTime | 10 | 12 | 13 | 600 | 300 | 20 |

In a scenario with reference to Table (1), the management server may identify a degradation of service between 3:00 μm and 4:00 pm using data from a trace route procedure. In this example, the frequency of the task is set to occur every ten minutes, producing six samples to measure the link as shown in Table (1). From these samples, the management server may determine that a network issue (e.g., the worst network degradation) occurs at 3:30 pm. For instance, the management server may determine that above-threshold (e.g., above-average) network degradation occurred at 3:30 pm and 3:40 pm.

In some examples, an absolute value(s), average(s), mean(s), rolling average(s), weighted average(s), variance(s), and/or standard deviation(s) may be utilized to identify a variation in a value or values described herein. For example, a threshold or thresholds described herein may be set relative to an absolute value(s), average(s), mean(s), rolling average(s), weighted average(s), variance(s), and/or standard deviation(s) of value(s). For instance, a data collection threshold and/or a threshold to identify a network issue may be set relative to an absolute value, average, mean, rolling average, weighted average, variance, and/or standard deviation of a value or values described herein.

In another scenario with reference to Table (1), the management server (in addition to interval, for instance) may set thresholds, where “max” may indicate that a threshold is satisfied if the threshold is exceeded and “min” may indicate that a threshold is satisfied if the corresponding value is less than the threshold. For example, if RoundtripTimeMax is set to 100, the managed node may send an event (e.g., data) to the server corresponding to the data collected at 3:30 PM and 3:40 PM.

Table (2) is another example of data collected by a managed node.

TABLE 2

| ExecutionTime | 15:00 | 15:10 | 15:50 |
|---|---|---|---|
| Latency | 200 | 300 | 200 |
| PacketLost | 0 | 0 | 0 |
| RoundtripTime | 10 | 12 | 20 |
| LastBootTime | 08/17/2021 | 08/17/2021 | 08/21/2021 |
| | 09:00:20 | 09:00:20 | 15:41:20 |

In a scenario with reference to Table (2), the management server may identify a network issue where data is missing due to a power failure. For example, the managed node may not have sent data corresponding to 3:10 pm and 3:50 pm due to a power failure. The management server may determine the blackout period by comparing LastBootTime value with the previous data collection. In some examples, the data may include a boot time and identifying 104 the network issue may include determining a power outage period based on the boot time.

Listing (2) illustrates an example of a task to collect data using a socket procedure over WI-FI in accordance with some of the techniques described herein.

```
{
  “TaskID”: “{unique-ID}”,
  “Type”: “Websocket”,
  “Target”: “Target-Host”,
  “Thresholds”: [{
    “Interval”: “10 minutes”,
    “PacketLostMax”: “”,
    “LatencyMax”: “”,
    “RoundtripMax”: “”,
    “WlanSignalMin”: “50”
  }],
  “Results”: [{
    “ExecutionTime”: “08/21/2021 15:00:05”,
    “Hops”: “”,
    “Latency”: “200 ms”,
    “PacketLost”: “0”,
    “RoundtripTime”: “10 ms”,
    “NetworkType”: “wlan”,
    “NetworkSpeed”: “54 Mbps”,
    “WlanAP”: “WifiSSID”,
    “WlanSignal”: “85%”,
    “LastBootTime”: “08/17/2021 09:00:20”
  }]
}
```

### Listing (2)

In the example of Listing (2), a web socket procedure may be performed by a managed node to collect data about the link between the managed node and a target device (e.g., unmanaged target device). In this example, the wireless access point identifier is a WI-FI service set identifier (e.g., “WifiSSID”).

Table (3) is another example of data collected by a managed node.

TABLE 3

| ExecutionTime | 15:00 | 15:10 | 15:20 | 15:30 | 15:40 | 15:50 |
|---|---|---|---|---|---|---|
| Latency | 100 | 200 | 300 | 1300 | 390 | 200 |
| PacketLost | 0 | 0 | 0 | 20 | 2 | 0 |
| RoundtripTime | 10 | 12 | 13 | 1200 | 200 | 20 |
| WlanSignal | 100 | 90 | 90 | 35 | 70 | 90 |

In a scenario with reference to Table (3), the management server may identify a network issue (e.g., network degradation) occurring between 3:00 pm and 4:00 pm. From the data collected, the management server may identify a network issue (e.g., the worst network degradation occurred at 3:30 pm and/or that network degradation above average occurred at 3:30 pm and 3:40 pm). The management server may aggregate the data between this managed node and another managed node that is on a wired network. Using this data, the management node may determine whether the network degradation is due to a wireless signal quality degradation or other network degradation in the area.

Listing (3) illustrates an example of a task to collect data using a third party API procedure in accordance with some of the techniques described herein. For instance, a managed node may collect data (e.g., network statistics) using an API provided by Zoom.

```
{
  “TaskID”: “{unique-ID}”,
  “Type”: “ZoomAPI”,
  “Target”: “Target-Host”,
  “Thresholds”: [{
    “Interval”: “10 minutes”,
    “PacketLostMax”: “”,
    “LatencyMax”: “”,
    “RoundtripMax”: “”,
    “WlanSignalMin”: “”
  }],
  “Results”: [{
    “ExecutionTime”: “08/21/2021 15:00:05”,
    “Hops”: “”,
    “Latency”: “200 ms”,
    “PacketLost”: “0”,
    “RoundtripTime”: “10 ms”,
    “NetworkType”: “wlan”,
    “NetworkSpeed”: “54 Mbps”,
    “WlanAP”: “WifiSSID”,
    “WlanSignal”: “85%”,
    “LastBootTime”: “08/17/2021 09:00:20”
  }]
}
```

### Listing (3)

In some examples, operation(s), function(s), and/or element(s) of the method 100 may be omitted and/or combined. For instance, an element or elements of the method 100 may be combined with another element or elements described herein.

Some examples of the techniques described herein may be utilized for a managed link(s). For instance, similar techniques may be utilized collect data corresponding to a managed link, to identify a network issue with a managed link, to generate a notification, etc., as are described in terms of an unmanaged link(s). Some examples of the techniques described herein may be utilized within a network (e.g., managed network, intranet, Internet, etc.), on the Internet, outside of a managed network, and/or on a combination of networks (e.g., intranet and Internet, WLAN and Internet, etc.).

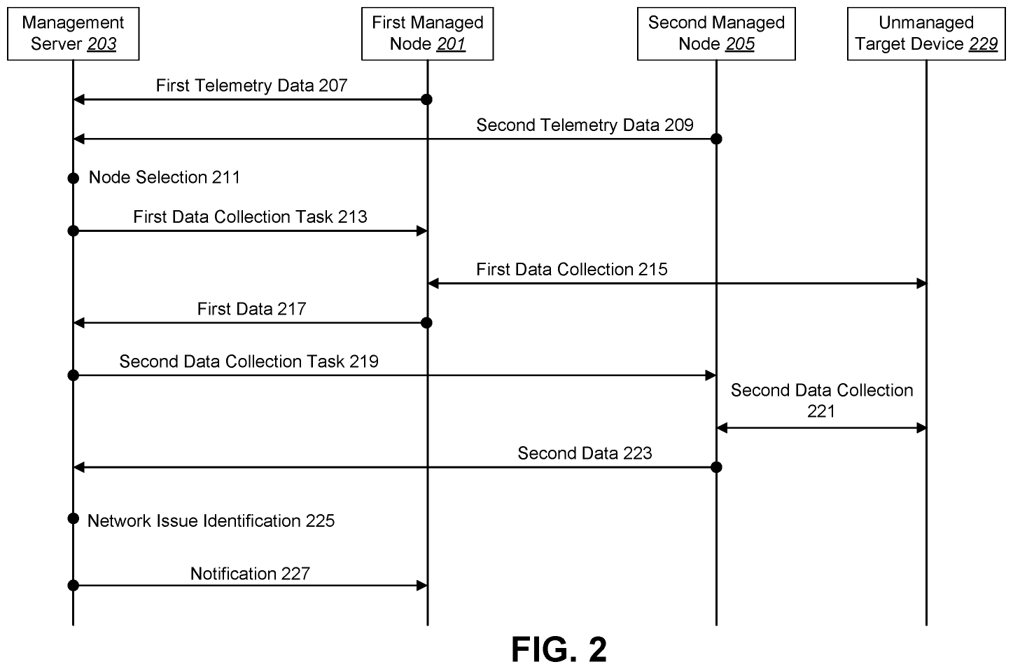

FIG. 2 is a thread diagram illustrating an example of network issue identification. FIG. 2 illustrates examples of a first managed node 201, a management server 203, a second managed node 205, and an unmanaged target device 229. In some examples, more managed nodes (not shown in FIG. 2) may be utilized. In some examples, the first managed node 201, the management server 203, and/or the second managed node 205 may be examples of the first device, apparatus, and/or second device described in relation to FIG. 3.

At 207, the first managed node 201 may send first telemetry data to the management server 203. For instance, a first agent on the first managed node 201 may measure and/or collect telemetry data on the first managed node 201 and may send the first telemetry data to the management server 203. In some examples, sending the first telemetry data may be performed as described in relation to FIG. 1.

At 209, the second managed node 205 may send second telemetry data to the management server 203. For instance, a second agent on the second managed node 205 may measure and/or collect telemetry data on the second managed node 205 and may send the second telemetry data to the management server 203. In some examples, sending the second telemetry data may be performed as described in relation to FIG. 1.

At 211, the management server 203 may perform node selection. In some examples, selecting a managed node(s) may be performed as described in relation to FIG. 1. In the example of FIG. 2, the first managed node 201 and the second managed node 205 may be selected. For instance, the first telemetry data and the second telemetry data may indicate that the first managed node 201 and the second managed node 205 have a threshold quantity of resources to perform data collection.

At 213, the management server 203 may send a first data collection task to the first managed node 201. In some examples, sending the first data collection task may be performed as described in relation to FIG. 1.

At 215, the first managed node 201 may perform first data collection. In some examples, the first data collection may be performed as described in relation to FIG. 1. For instance, the first managed node 201 may perform a data collection procedure (e.g., trace route procedure, socket procedure, and/or third party API procedure, etc.) on a first link with the unmanaged target device 229.

At 217, the first managed node 201 may send the first data to the management server 203. In some examples, sending the first data to the management server 203 may be performed as described in relation to FIG. 1.

At 219, the management server 203 may send a second data collection task to the second managed node 205. In some examples, sending the second data collection task may be performed as described in relation to FIG. 1.

At 221, the second managed node 205 may perform second data collection. In some examples, the second data collection may be performed as described in relation to FIG. 1. For instance, the second managed node 205 may perform a data collection procedure (e.g., trace route procedure, socket procedure, and/or third party API procedure, etc.) on a second link with the unmanaged target device 229.

At 223, the second managed node 205 may send the second data to the management server 203. In some examples, sending the second data to the management server 203 may be performed as described in relation to FIG. 1.

At 225, the management server 203 may perform network issue identification. In some examples, the management server 203 may perform network issue identification as described in relation to FIG. 1. For instance, the management server 203 may compare the first data and/or the second data to a threshold or thresholds. The management server 203 may identify a network issue in a case that a threshold is satisfied. In some examples, the management server 203 may compare the first data and the second data to identify a network issue. For instance, the management server 203 may determine whether the first data is significantly different (e.g., ±10%, ±15%, ±18%, ±25%, ±30%, etc.) from the second data. For example, if a latency indicated by the first data is 30% less than a latency indicated by the second data, the management server 203 may determine a cause for the difference (e.g., geographic location difference, network type difference, poor routing performance, a downed server, etc.). In some examples, the difference may indicate the network issue.

At 227, the management server 203 may send a notification to the first managed node 201. In some examples, sending a notification to a managed node may be performed as described in relation to FIG. 1. For instance, the management server 203 may send a notification indicating the network issue to the first managed node (e.g., poor wireless signal quality, a malfunctioning server, high network load, etc.).

FIG. 3 is a block diagram of an example of an apparatus 302 that may be used for network issue identification. The apparatus 302 may be a computing device. The apparatus 302 may include a processor 304, a memory 306, and/or a communication interface 324. The apparatus 302 may include additional components (not shown) and/or some of the components described herein may be removed and/or modified without departing from the scope of this disclosure.

The processor 304 may be any of a central processing unit (CPU), a digital signal processor (DSP), a semiconductor-based microprocessor, graphics processing unit (GPU), field-programmable gate array (FPGA), an application-specific integrated circuit (ASIC), and/or other hardware device suitable for retrieval and execution of instructions stored in the memory 306. The processor 304 may fetch, decode, and/or execute instructions stored in the memory 306. In some examples, the processor 304 may include an electronic circuit or circuits that include electronic components for performing a function or functions of the instructions. In some examples, the processor 304 may perform one, some, or all of the operations, aspects, etc., described in relation to one, some, or all of FIGS. 1-4. For example, the memory 306 may store instructions for one, some, or all of the operations, aspects, etc., described in relation to one, some, or all of FIGS. 1-4. The processor 304 may be coupled to (e.g., may be in electronic communication with) the memory 306.

The memory 306 may be any electronic, magnetic, optical, or other physical storage device that contains or stores electronic information (e.g., instructions and/or data). The memory 306 may be, for example, Random Access Memory (RAM), EEPROM, a storage device, an optical disc, and/or the like. In some examples, the memory 306 may be volatile and/or non-volatile memory, such as Dynamic Random Access Memory (DRAM), EEPROM, magnetoresistive random-access memory (MRAM), phase change RAM (PCRAM), memristor, flash memory, and/or the like. In some examples, the memory 306 may be a non-transitory tangible machine-readable storage medium, where the term “non-transitory” does not encompass transitory propagating signals. In some examples, the memory 306 may include multiple devices (e.g., a RAM card and a solid-state drive (SSD)). In some examples, the memory 306 of the apparatus 302 may store communication instructions 310 and/or detection instructions 312.

In some examples, the apparatus 302 may include a communication interface 324 through which the processor 304 may communicate with an external device or devices (e.g., the first device 328 and/or the second device 308). In some examples, the apparatus 302 may be in communication with (e.g., have a communication link with) the first device 328 and/or the second device 308 via a network or networks 326. Examples of the first device 328 may include a computing device. Examples of the second device 308 may include a computing device. In some examples, the first device 328 may be an example of a first managed node and/or the second device 308 may be an example of a second managed node. In some examples, the first device 328 may include and/or execute a first agent (not shown in FIG. 3). In some examples, the second device 308 may include and/or execute a second agent (not shown in FIG. 3). Examples of the network(s) 326 may include a local area network (LAN), wide area network (WAN), the Internet, cellular network, Long Term Evolution (LTE) network, mesh network, Bluetooth network, 5G network, and/or combinations thereof, etc. In some examples, the apparatus 302 may be a cloud device. In some examples, the apparatus 302 may be a management server.

The communication interface 324 may include hardware and/or machine-readable instructions to enable the processor 304 to communicate with the first device 328 and/or the second device 308. The communication interface 324 may enable a wired and/or wireless connection to the first device 328 and/or to the second device 308. In some examples, the communication interface 324 may include a network interface card and/or may also include hardware and/or machine-readable instructions to enable the processor 304 to communicate with the first device 328 and the second device 308. In some examples, the communication interface 324 may include hardware (e.g., circuitry, ports, connectors, antennas, etc.) and/or machine-readable instructions to enable the processor 304 to communicate various input and/or output devices, such as a keyboard, a mouse, a display, another apparatus, electronic device, computing device, etc., through which a user may input instructions and/or data into the apparatus 302. In some examples, the apparatus 302 (e.g., processor 304) may utilize the communication interface 324 to send and/or receive information.

In some examples, the first device 328 may include a processor, memory, and/or communication interface. In some examples, the memory of the first device 328 may be any electronic, magnetic, optical, or other physical storage device that contains or stores electronic information (e.g., instructions and/or data), such as, for example, RAM, EEPROM, a storage device, an optical disc, and/or the like. In some examples, the processor of the first device 328 may be any of a CPU, a DSP, a semiconductor-based microprocessor, GPU, FPGA, an ASIC, and/or other hardware device suitable for retrieval and execution of instructions stored in corresponding memory. In some examples, the communication interface of the first device 328 may include hardware and/or machine-readable instructions to enable the first device 328 to communicate with the apparatus 302 and/or with the second device 308.

In some examples, the second device 308 may include a processor, memory, and/or communication interface. In some examples, the memory of the second device 308 may be any electronic, magnetic, optical, or other physical storage device that contains or stores electronic information (e.g., instructions and/or data), such as, for example, RAM, EEPROM, a storage device, an optical disc, and/or the like. In some examples, the processor of the second device 308 may be any of a CPU, a DSP, a semiconductor-based microprocessor, GPU, FPGA, an ASIC, and/or other hardware device suitable for retrieval and execution of instructions stored in corresponding memory. In some examples, the communication interface of the second device 308 may include hardware and/or machine-readable instructions to enable the second device 308 to communicate with the apparatus 302 and/or with the first device 328.

In some examples, the processor 304 may execute the communication instructions 310 to send and/or receive data using the communication interface 324. For example, the communication interface 324 may send a first data collection task to a first agent of the first device 328. In some examples, the communication interface 324 may send the first data collection task to the first device 328 as described in relation to FIG. 1 and/or FIG. 2. For instance, the first data collection task may indicate a data collection threshold (e.g., a threshold that if satisfied triggers data collection and/or reporting).

The communication interface 324 may receive, from the first agent in response to the first data collection task, first data corresponding to a first unmanaged link between the first device 328 and an unmanaged target device (not shown in FIG. 3). In some examples, the communication interface 324 may receive the first data as described in relation to FIG. 1 and/or FIG. 2. For instance, the first device 328 may collect the first data using a procedure via a link between the first device 328 and an unmanaged target device. In some examples, the link may be carried on the network(s) 326 or another network(s).

In some examples, the communication interface 324 may send a second data collection task to a second agent of the second device 308. In some examples, the communication interface 324 may send the second data collection task to the second device 308 as described in relation to FIG. 1 and/or FIG. 2.

The communication interface 324 may receive, from the second agent in response to the second data collection task, second data corresponding to a second unmanaged link between the second device 308 and an unmanaged target device (not shown in FIG. 3). In some examples, the communication interface 324 may receive the second data as described in relation to FIG. 1 and/or FIG. 2. For instance, the second device 308 may collect the second data using a procedure on a link between the second device 308 and an unmanaged target device. In some examples, the link may be carried on the network(s) 326 or another network(s).

The processor 304 may execute the detection instructions 312 to detect a network issue with the first unmanaged link based on the first data and the second data. In some examples, the processor 304 may detect the network issue as described in relation to FIG. 1 and/or FIG. 2.

In some examples, the processor 304 may execute the communication instructions 310 to send, via the communication interface 324, a traffic rerouting task to the first agent in response to the network issue. In some examples, sending the traffic rerouting task to the first agent may be performed as described in relation to FIG. 1. For instance, the apparatus 302 may send a task to the first agent instructing the first agent to use a link to a different unmanaged target device or instructing the first agent to direct traffic to the unmanaged target device via a different route or path.

In some examples, the processor 304 may select the first device 328 as a representative device of a first set of devices based on telemetry data received from the first device 328. In some examples, selecting a device as a representative device may be performed as described in relation to FIG. 1. For example, the apparatus 302 may select the first device 328 as a representative device of other devices in a similar geographic area and/or that use a similar route to link to an unmanaged target device.

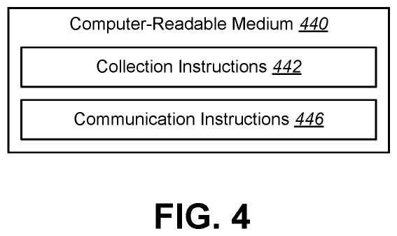

FIG. 4 is a block diagram illustrating an example of a computer-readable medium 440 for network issue identification. The computer-readable medium 440 is a non-transitory, tangible computer-readable medium 440. The computer-readable medium 440 may be, for example, RAM, EEPROM, a storage device, an optical disc, and/or the like. In some examples, the computer-readable medium 440 may be volatile and/or non-volatile memory, such as DRAM, EEPROM, MRAM, PCRAM, memristor, flash memory, and/or the like. In some examples, the memory 306 described in relation to FIG. 3 may be an example of a computer-readable medium of a managed node described in relation to FIG. 1, FIG. 2, and/or FIG. 3.

The computer-readable medium 440 includes data (e.g., instructions, executable code, application(s), program(s), and/or information). For example, the computer-readable medium 440 may include collection instructions 442 and/or communication instructions 446.

The communication instructions 446 may be executed by a processor to receive, at a managed node, a data collection task from a management server. In some examples, receiving a data collection task may be performed as described in relation to FIG. 1, FIG. 2, and/or FIG. 3. For instance, a managed node may receive a data collection task from a management server over a network or networks. In some examples, the data collection task includes a data collection threshold.

The collection instructions 442 may be executed by the processor to collect, based on the data collection task, data corresponding to an unmanaged link between the managed node and an unmanaged target device. In some examples, collecting data may be performed as described in relation to FIG. 1, FIG. 2, and/or FIG. 3. In some examples, the collection instructions 442 may be executed by the processor to determine that the data collection threshold is satisfied. In some examples, the collection instructions 442 may be executed by the processor to send the data to the management server in response to determining that the data collection threshold is satisfied.

The communication instructions 446 may be executed by the processor to send the data to the management server from the managed node. In some examples, sending the data may be performed as described in relation to FIG. 1, FIG. 2, and/or FIG. 3. For instance, the managed node may send data to a management server over a network or networks. The data may correspond to an unmanaged link between the managed node and the unmanaged target device.

The communication instructions 446 may be executed by the processor to receive, at the managed node, a notification of a network issue identified by the management server. In some examples, receiving the notification may be performed as described in relation to FIG. 1, FIG. 2, and/or FIG. 3. For instance, the managed node may receive a notification from a management server over a network or networks.

Some examples of the techniques described herein may provide network information (e.g., network issue information), whether a managed node is within a company's network (e.g., intranet-connected managed node) or outside of the company's network (e.g., Internet-connected managed node). Some examples of the techniques described herein may enable dynamic link setup based on network health information (e.g., identified network issue(s)) to enhance network performance. Some examples of the techniques described herein may provide end-user notification detailing a root cause of a network issue without contacting an IT administrator.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples of systems and methods are described herein, the systems and methods are not limited to the examples. Variations of the examples described herein may be implemented within the scope of the disclosure. For example, operations, aspects, and/or elements of the examples described herein may be omitted or combined.

1. A method, comprising:
receiving, at a management server, network performance information from a managed node, wherein the network performance information comprises data corresponding to an unmanaged link between the managed node and an unmanaged target device;
identifying a network issue with the unmanaged link based on the data; and
generating a notification indicating the network issue.

2. The method of claim 1, further comprising sending an instruction to the managed node to change a link route in response to identifying the network issue.

3. The method of claim 1, further comprising receiving, from a second managed node, second data corresponding to a second unmanaged link between the second managed node and the unmanaged target device, wherein identifying the network issue with the unmanaged link is based on the data and the second data.

4. The method of claim 3, wherein the unmanaged link includes a wireless link and the data comprises a wireless signal quality metric, wherein the second unmanaged link is a wired link, and wherein identifying the network issue comprises comparing the data and the second data.

5. The method of claim 1, further comprising sending a task to the managed node to collect the data.

6. The method of claim 5, wherein the task indicates a trace route procedure.

7. The method of claim 5, wherein the task indicates a socket procedure.

8. The method of claim 5, wherein the task indicates a third-party application programming interface (API) procedure.

9. The method of claim 1, wherein the data comprises a boot time, and wherein identifying the network issue comprises determining a power outage period based on the boot time.

10. An apparatus, comprising:
a communication interface to:
send a first data collection task to a first agent of a first device;
receive, from the first agent in response to the first data collection task, first data corresponding to a first unmanaged link between the first device and an unmanaged target device;
send a second data collection task to a second agent of a second device; and
receive, from the second agent in response to the second data collection task, second data corresponding to a second unmanaged link between the second device and the unmanaged target device;
a memory; and
a processor coupled to the memory, wherein the processor is to:
detect a network issue with the first unmanaged link based on the first data and the second data; and
send, via the communication interface, a traffic rerouting task to the first agent in response to the network issue.

11. The apparatus of claim 10, wherein the processor is to select the first device as a representative device of a first set of devices based on telemetry data received from the first device.

12. The apparatus of claim 10, wherein the first data collection task indicates a data collection threshold.

13. A non-transitory tangible computer-readable medium comprising instructions when executed cause a processor to:
receive, at a managed node, a data collection task from a management server;
collect, based on the data collection task, data corresponding to an unmanaged link between the managed node and an unmanaged target device;
send the data to the management server from the managed node; and
receive, at the managed node, a notification of a network issue identified by the management server.

14. The non-transitory tangible computer-readable medium of claim 13, wherein the data collection task includes a data collection threshold.

15. The non-transitory tangible computer-readable medium of claim 14, further comprising instructions when executed cause the processor to:
determine that the data collection threshold is satisfied; and
send the data to the management server in response to determining that the data collection threshold is satisfied.
